(19) United States
(12) Patent Application Publication
(10) Pub. No.: US 2003/0024650 A1
(43) Pub. Date: Feb. 6, 2003

(54) Device for centering a container provided with a reference on a pan in a labeling machine

(75) Inventor: Mario Ballarotti, Marmirolo (IT)

Correspondence Address: MODIANO & ASSOCIATI, Via Meravigli, 16, MILANO, 20123, IT

(73) Assignee: P.E. S.R.L.

(21) Appl. No.: 10/196,945

(22) Filed: Jul. 18, 2002

(30) Foreign Application Priority Data
Aug. 2, 2001 (IT) MN2001A000034

(51) Int. Cl. B65C 9/00

(52) U.S. Cl. 156/566; 156/567

(57) ABSTRACT

A device for centering a container provided with a reference on a pan in a labeling machine, comprising elements adapted to determine, by making contact with the reference provided on the container, the locking of the container in the direction of rotation of the resetting motion, leaving the container free to rotate together with the pan when the pan rotates in the direction of the motion that occurs during labeling.

### BACKGROUND OF THE INVENTION

The present invention relates to a device for centering a container provided with a reference on a pan in a labeling machine.

The structure of machines for labeling containers such as bottles and cans is known which comprises a rotating carousel provided with pans, each pan being designed to support a container that is conveyed to the pan by an input star conveyor; during the rotation of the carousel, the container makes contact with one or more labeling assemblies located in the peripheral region of the carousel and is finally removed by means of an output star conveyor.

A functional condition occurs in these machines by way of which every pan is turned, starting from the position for receiving a container, initially for a resetting motion that occurs in one direction and then in the opposite direction during labeling.

It is also known that some kinds of container have a surface that is shaped SO as to require the application of one or more labels in a very specific position; accordingly, when each container arrives at the beginning of the labeling operation it must be rested on the corresponding pan with a very precise orientation; the term “centering” designates the operation that moves a container from the random orientation that it has on the pan when it is placed thereon by the input star conveyor to the very precise orientation required for correct labeling.

Known devices that provide container centering by utilizing the presence of a reference provided on the surface of said containers have characteristics that are not entirely satisfactory.

### SUMMARY OF THE INVENTION

The aim of the present invention is thus to provide a centering device that is extremely simple and safe in operation.

This aim is achieved by a device for centering a container provided with a reference on a pan in a labeling machine, according to the invention, said pan, mounted on a rotating carousel, being adapted to receive, rested thereon, a container that is conveyed to it by an input star conveyor and being turned, starting from the container receiving position, first for a resetting motion that occurs in one direction and then in an opposite direction during labeling, comprising means that are suitable to determine, by making contact with the reference provided on the container, locking of the container in the direction of rotation of the resetting motion, leaving the container free to rotate together with the pan when said pan rotates in the direction of the motion that occurs during labeling.

### BRIEF DESCRIPTION OF THE DRAWINGS

Further characteristics and advantages of the invention will become better apparent from the following detailed description of a preferred but not exclusive embodiment thereof, illustrated only by way of non-limitative example in the accompanying drawings, wherein:

FIG. 1 is a plan view of a labeling machine provided with devices according to the invention;

FIG. 2 is an enlarged-scale view of a detail of FIG. 1, with containers present;

FIGS. 3 and 4 are respectively a perspective view and a schematic plan view of a container during centering;

FIGS. 5 and 6 are respectively a perspective view and a schematic plan view of a container at the end of centering.

### DESCRIPTION OF THE PREFERRED EMBODIMENTS

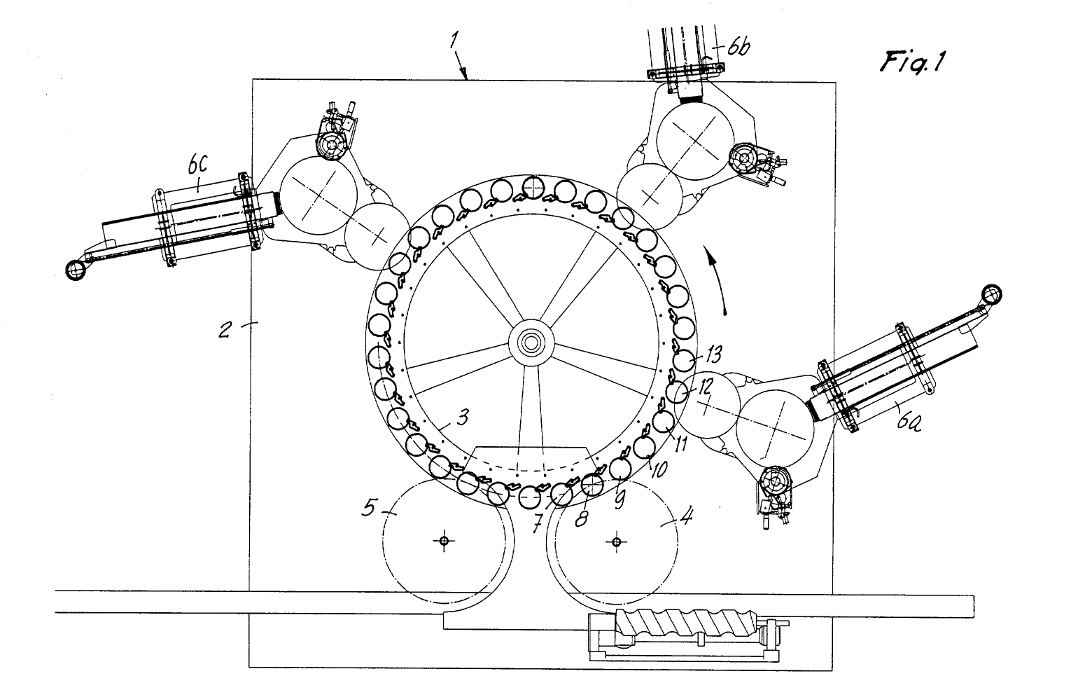

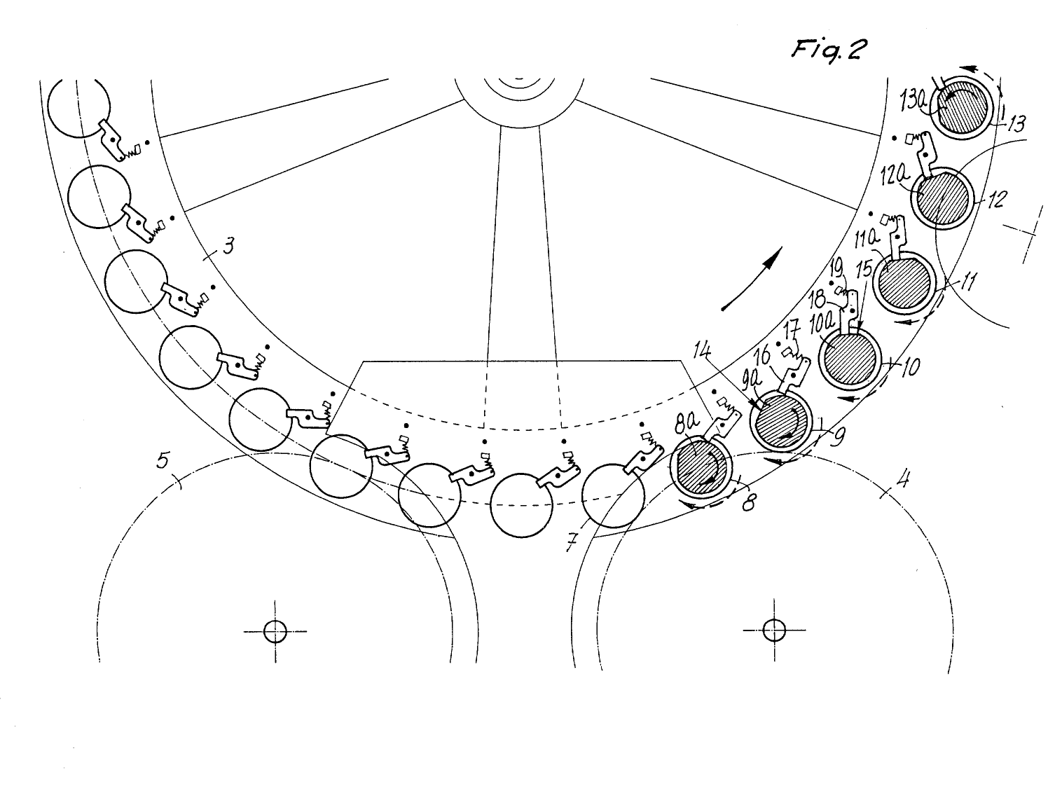

With reference to the figures, the reference numeral 1 generally designates a labeling machine, which comprises, on a footing 2, a carousel 3, which rotates in the direction of the arrows shown in FIGS. 1 and 2, an input star 4, an output star 5, and labeling assemblies 6a, 6b and 6c.

The rotating carousel 3 supports a plurality of pans such as 7, 8, 9, 10, 11, 12 and 13, each meant to receive and support a container that is conveyed to it by the input star 4, and the reference numerals 8a, 9a, 10a, 11a, 12a, 13a designate containers rested respectively on the pans 8, 9, 10, 11, 12 and 13.

Each pan is turned, starting from the position for receiving a container and therefore in the illustrated case from the position occupied by the pan 8, first for a resetting motion, which occurs clockwise along the arrows drawn in dashed lines, and then, after a short stop at the position occupied by the pan 12, the pan is turned counterclockwise starting from the position occupied by the pan 13 in order to perform the labeling operation.

All this occurs in a known manner.

A characteristic of the invention is the presence, for each pan, of a device for centering on the pan the container that is present, which is of the kind of the containers 9a, 10a that have a flat recessed reference face such as 14, 15 that comprises means suitable to determine, by making contact with the flat reference, provided on the container, the locking of the container in the direction of rotation of the resetting motion, leaving it free to rotate together with the respective pan when it rotates in the direction that it assumes during labeling.

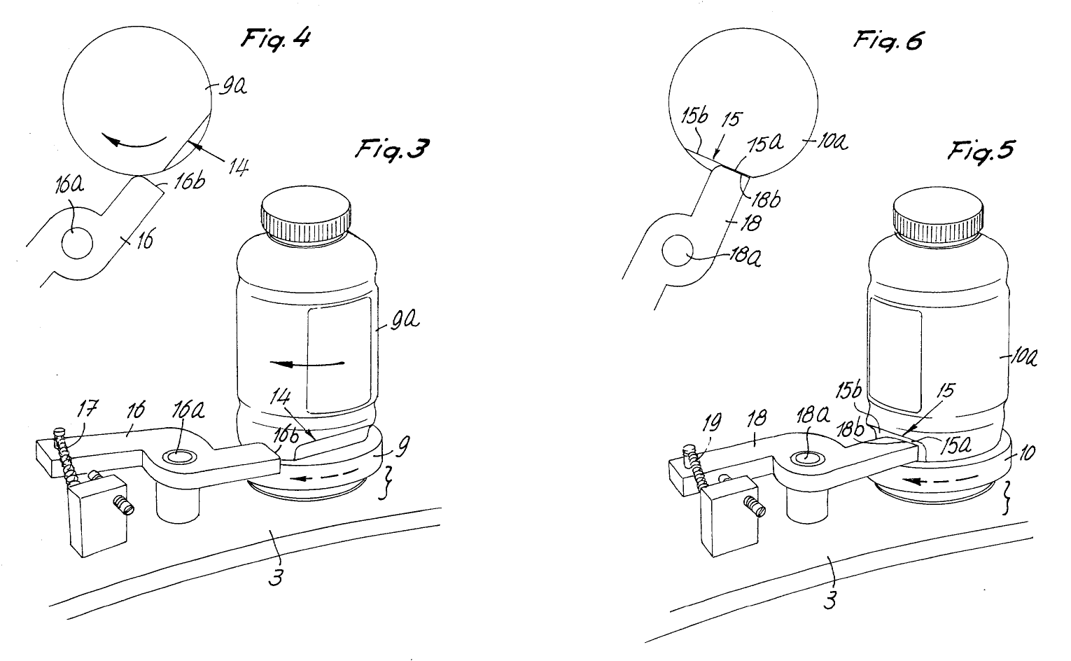

Such devices are all identical, and FIGS. 3 and 4 show in detail the device related to the pan 9, which comprises a lever 16, which is pivoted to the carousel 3 at 16a with a rotation axis that is parallel to the rotation axis of the pan 9, and is kept in contact, by a spring 17, with the container 9a rested on the pan 9.

The lever 16 has a flat end 16b that is suitable to rest on the flat recessed reference face of a container in the manner explained hereafter with reference to the device related to the pan 10 that is visible in FIGS. 5 and 6.

The device comprises a lever 18, which is pivoted at 18a to the carousel 3 with a rotation axis that is parallel to the rotation axis of the pan 10 and is kept in contact, by a spring 19, with the container 10a that rests on the pan 10.

The lever 18 has a flat end 18b, which is suitable to rest on the recessed flat face 15 of the container 10a when it is arranged at right angles to the imaginary plane that passes through the rotation axes of the lever 18 and of the pan 10, only at the region 15a of the recessed face that is entirely located on one side with respect to such plane, without affecting the region 15b that lies on the other side; in this manner, the container 10a is blocked from performing a rotation in the clockwise resetting direction and is instead free to rotate in the counterclockwise direction to be adopted during labeling.

As mentioned, this applies to the devices related to all the pans.

The operation of the invention is now described.

The pan 7 is motionless.

The pan 8 has just received the container 8a, which is rested thereon, and is rotated clockwise in the direction of the arrow drawn in dashed lines for the resetting motion; the container 8a rotates rigidly with the pan 8 in the direction of the arrow drawn in solid lines, because the lever of the corresponding centering device provides no interference at all.

The pan 9 is rotating for the resetting motion in a clockwise direction with the container 9a rigidly coupled thereto: substantially, the motions of the pan and of the container indicated by the respective arrows and started when the pan 9 was in the position now occupied by the pan 8, continue.

The pan 10 is rotating for the resetting motion in the direction of the arrow drawn in dashed lines, and the container 10a is blocked due to the centering device; the end 18b of the lever 18 has in fact made contact with the region 15a of the recessed face 15 provided on the container 10a.

The pan 11 is turning in its resetting motion and slips beneath the container 11a, which is locked by the respective centering device.

The pan 12 is motionless, since it has ended its resetting motion, and is ready to restart in the opposite direction for the motion to be performed during labeling, and the container 12a that is rested thereon is centered in contact with the corresponding centering device, which is perfectly orientated for correctly performing the labeling operation that follows immediately.

The pan 13 rotates in the counterclockwise direction, indicated by the arrow drawn in dashed lines, of the labeling operation, and the container 13a rotates in the same direction as indicated by the arrow drawn in solid lines, so that it is rotates together with the underlying pan and is not hindered in doing so, as mentioned, by the presence of the lever of the corresponding centering device.

The described invention is susceptible of numerous modifications and variations, all of which are within the scope of the inventive concept; thus, for example, the means suitable to lock the containers may assume any shape.

The disclosures in Italian Patent Application No. MN2001A000034 from which this application claims priority are incorporated herein by reference.

What is claimed is:

1. A device for centering a container provided with a reference on a pan in a labeling machine, said pan, mounted on a rotating carousel, being adapted to receive, rested thereon, a container that is conveyed to the pan by an input star conveyor and being turned, starting from the container receiving position, first for a resetting motion that occurs in one direction and then in an opposite direction during labeling, comprising means that are suitable to determine, by making contact with the reference provided on the container, locking of said container in a direction of rotation of the resetting motion, leaving the container free to rotate together with the pan when said pan rotates in the direction of the motion that occurs during labeling.

2. The device according to claim 1 for centering a container provided with a recessed flat reference face, wherein the means suitable to determine, by making contact with the reference provided on the container, the locking of said container in the rotational direction of the resetting motion, leaving the container free to rotate together with the pan when said pan rotates in the direction of the motion that occurs during labeling, comprise a lever that is pivoted to the carousel proximate to the pan, with an axis of rotation that is parallel to an axis of rotation of said pan, and is kept in contact with the container that rests on a pan, said lever having a flat end that is suitable to rest on the recessed flat reference face of the container that is arranged at right angles to an imaginary plane that passes through the axes of rotation of the lever and of the pan only at a region that is entirely located, with respect to said plane, on a side that allows to contrast the rotary motion of said pan in the direction that occurs during the resetting motion.

3. The device according to claim 2, comprising elastic means suitable to keep the lever pivoted on the carousel proximate to the pan in contact with the container rested on said pan.
